(19) United States
(12) Patent Application Publication
(10) Pub. No.: US 2021/0232465 A1
(43) Pub. Date: Jul. 29, 2021

(54) GENERATION OF DATABASE BACKUPS IN RESPONSE TO ENVIRONMENTAL SIGNALS

(71) Applicant: salesforce.com, inc., San Francisco, CA (US)

(72) Inventor: Kyle Neier, Avon, IN (US)

(21) Appl. No.: 16/775,574

(22) Filed: Jan. 29, 2020

(51) Int. Cl. G06F 11/14

(52) U.S. Cl. CPC G06F 11/1469; G06F 2201/835; G06F 11/1451

(57) ABSTRACT

System and methods are described for generating database backups in response to environmental signals. In one implementation, a method comprises determining that a target backup is to be generated for a target database of a plurality of databases managed by a database system. A least one environmental signals associated with the database is identified, and an estimated time to perform a recovery operation for the target backup is computed based at least in part on the at least one environmental signal. The target backup is generated responsive to a determination that the estimated time to perform the recovery operation is compliant with a time restraint imposed on the database system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

One or more implementations relate to data recovery solutions, and, more specifically, to the management of database backups in a multi-tenant database environment.

### BACKGROUND

“Cloud computing” services provide shared resources, software, and information to computers and other devices upon request or on demand. A key challenge for cloud computing services is maintaining a data backup process that preserves data integrity while simultaneously managing large and continuously-growing quantities of data. Current data backup processes utilize a schedule based approach, for example, where full backups are scheduled followed by scheduled differential backups and scheduled incremental log backups to fill in recovery gaps. Current processes, however, lack the ability to map the generation of a backup to the requirements of a recovery point objective (RPO) or a recovery time objective (RTO), which are not based on schedules and are often unpredictable.

### BRIEF DESCRIPTION OF THE DRAWINGS

The included drawings are for illustrative purposes and serve to provide examples of possible structures and operations for the disclosed inventive systems, apparatus, methods, and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2A shows a system diagram of example architectural components of an on-demand database service environment according to some implementations.

FIG. 2B shows a system diagram further illustrating example architectural components of an on-demand database service environment according to some implementations.

FIG. 3 shows a block diagram of example implementations of a backup system according to some implementations.

FIG. 4 is a flow diagram illustrating an exemplary method for generating database backups in response to environmental signals according to some implementations.

FIG. 5 is a flow diagram illustrating an exemplary method for determining a type of backup to generate according to some implementations.

FIG. 6 illustrates a diagrammatic representation of a machine in the exemplary form of a computer system within which one or more implementations may be carried out.

### DETAILED DESCRIPTION

The implementations described herein relate to the generation of database backups in response to environmentally-derived signals. Specifically, certain implementations relate to the generation of backups based on historical data available from metrics such as, but not limited to, prior backups, signals from the computing environment, and/or predicted amounts of time different types of backups will take to restore. Such metrics are used to determine the type of backup to perform and when the backup should be generated.

Very large transactional databases (VLDB) presented a considerable challenge for backup methods utilizing a bulk backup approach utilizing only FULL backups, as there is no feasible way to speed up recovery using this approach. As an example, a 40 terabyte (TB) VLDB will take approximately 10-12 hours for generation of a FULL to complete. During this time, the transaction log cannot release records of any transactions that started after the FULL was initiated. This means that a transaction log could grow in excess of 3-4 TB during this 10-12 hour window. If a node or database failure occurs during this time, this may result in an extended outage of several hours due to the need to recover the database based upon the active transactions in the log.

Current backup processes include native structured query language (SQL) solutions from Microsoft, and other processes provided by CommVault, Redgate SQL Backup, Idera SQL Safe, and Quest LiteSpeed. The most common process is the SQL Server backup process, which involves scheduled full database (FULL) backups, followed by a scheduled differential database (DIFF) backups with scheduled transaction log (TLOG) backups to fill in the recovery gaps.

SQL Server provides a few options to mitigate the disadvantages of the FULL backup approach by implementing database file (FILE) backups, differential (DIFF) backups, and partial differential (PDIFF) backups. Every database is composed of multiple files in the operating system. A FULL backup will take the data from all files at once and place it in an archive so that a full recovery can be completed. A FILE backup will specify a single file from which to extract data and keep it archived. The FILE backup thus limits the exposure of the log growth while allowing the recovery to be stitched together with TLOG backups. A PDIFF allows a differential to be taken from specific files such that only the portions of the file that have changed are read and archived. This approach can significantly accelerate the recovery process as it utilizes a snapshot of the changes at a point in time, and not every change as would be required by a TLOG backup.

While current methods for generating backups manage and utilize various types of backups, these methods generate backups based on schedules and not feedback from a backup system. For example, a backup process may generate a FULL backup weekly, a DIFF or PDIFF backup daily, and TLOG backup every 15 minutes. While such an approach may provide a predictable RPO, advanced scheduling techniques should be implemented to avoid putting pressure on the performance of the system. In addition, an RTO can be highly unpredictable given the unpredictable amount of changes that could take place in a system over the course of a day or even shorter period. Current schedule-based systems thus lack the flexibility to adapt to these requirements in a practical and efficient manner, at least partially due to their failure to account for the amount of time needed to perform a restore.

The implementations described herein address these and other limitations of current systems by utilizing environmental signals to drive backup generation. In some implementations, a method for generating backups includes utilizing environmental signals, such as transaction log size and bandwidth availability, to determine what type of backups to generate and when the backups should be generated in order to meet service-level agreement (SLA) requirements. In some implementations, no backup schedules are used. Instead, backups are taken as determined by the system based on the environmental signals.

Advantages of the implementations of the disclosure over current systems include, but are not limited to: (1) efficient need-based backup generation based upon environmental signals, RPO requirements, RTO requirements, and any compliance requirements; (2) backups generated based on strict schedules avoided, which prevents the system from being overwhelmed when file sizes are large (as is typically the case in multi-tenant database systems); and (3) decision-making logic to determine whether backup compliance can be achieved with simple scheduling based on computed time requirements for restores, or, if not, then by generation based on environmental signals.

As used herein, the terms “backup” or “database backup” refer generally to a snapshot of a database at a particular point in time. The backup may be a complete copy of all data in the database or a subset of all data (e.g., a file of the database).

Also as used herein, the term “environmental signal” refers to any telemetry data gathered by a system pertaining to the operation of the system, such as, but not limited to, data transfer capacity, data processing speed, storage capacity, historical performance data, workload conditions, and changes in any of these quantities.

Also as used herein, the term “transaction log” refers to a running chronologically-ordered list of all changes that have occurred in a database. In some implementations, transaction log data is used to compute an estimated amount of time to perform a restore.

Also as used herein, the term “recovery time objective” or “RTO” refers to a point in time after a failure event by which a recovery operation must be completed according to a data policy.

Also as used herein, the term “recovery point objective” or “RPO” refers to an acceptable amount of data loss according to a data policy measured in time starting from a failure event (e.g., a maximum of one week of data prior to a failure event).

Examples of systems, apparatuses, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B, or C” is intended to include the possibilities of “A,” “B,” “C,” “A and B,” “B and C,” “A and C,” and “A, B, and C.”

The words “example” or “exemplary” are used herein to mean serving as an example, instance, or illustration. Any aspect or design described herein as an “example” or “exemplary” is not necessarily to be construed as preferred or advantageous over other aspects or designs. Rather, use of the words “example” or “exemplary” is intended to present concepts in a concrete fashion.

In addition, the articles “a” and “an” as used herein and in the appended claims should generally be construed to mean “one or more” unless specified otherwise or clear from context to be directed to a singular form. Reference throughout this specification to “an implementation,” “one implementation,” “some implementations,” or “certain implementations” indicates that a particular feature, structure, or characteristic described in connection with the implementation is included in at least one implementation. Thus, the appearances of the phrase “an implementation,” “one implementation,” “some implementations,” or “certain implementations” in various locations throughout this specification are not necessarily all referring to the same implementation.

Some portions of the detailed description may be presented in terms of algorithms and symbolic representations of operations on data bits within a computer memory. These algorithmic descriptions and representations are the manner used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “retrieving,” “transmitting,” “computing,” “generating,” “adding,” “subtracting,” “multiplying,” “dividing,” “optimizing,” “calibrating,” “detecting,” “performing,” “analyzing,” “determining,” “enabling,” “identifying,” “modifying,” “transforming,” “applying,” “aggregating,” “extracting,” “registering,” “querying,” “populating,” “hydrating,” “updating,” “mapping,” “causing,” “storing,” “prioritizing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission, or display devices.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM, and the like without departing from the scope of the implementations claimed. Moreover, the implementations are applicable to other systems and environments including, but not limited to, client-server models, mobile technology and devices, wearable devices, and on-demand services.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Any of the software components or functions described in this application can be implemented as software code to be executed by one or more processors using any suitable computer language such as, for example, C, C++, Java™ (which is a trademark of Sun Microsystems, Inc.), or Perl using, for example, existing or object-oriented techniques. The software code can be stored as non-transitory instructions on any type of tangible computer-readable storage medium (referred to herein as a “non-transitory computer-readable storage medium”). Examples of suitable media include random access memory (RAM), read-only memory (ROM), magnetic media such as a hard-drive or a floppy disk, or an optical medium such as a compact disc (CD) or digital versatile disc (DVD), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

The disclosure also relates to apparatuses, devices, and system adapted/configured to perform the operations herein. The apparatuses, devices, and systems may be specially constructed for their required purposes, may be selectively activated or reconfigured by a computer program, or some combination thereof.

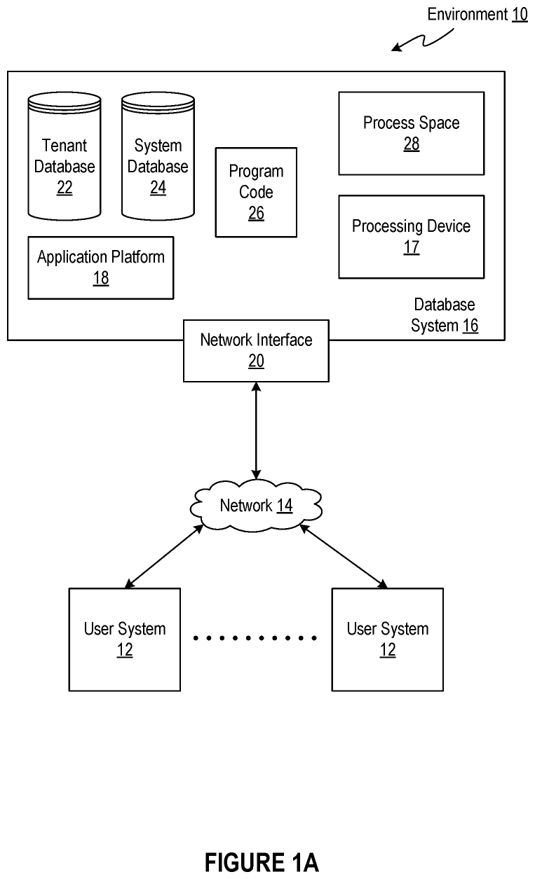

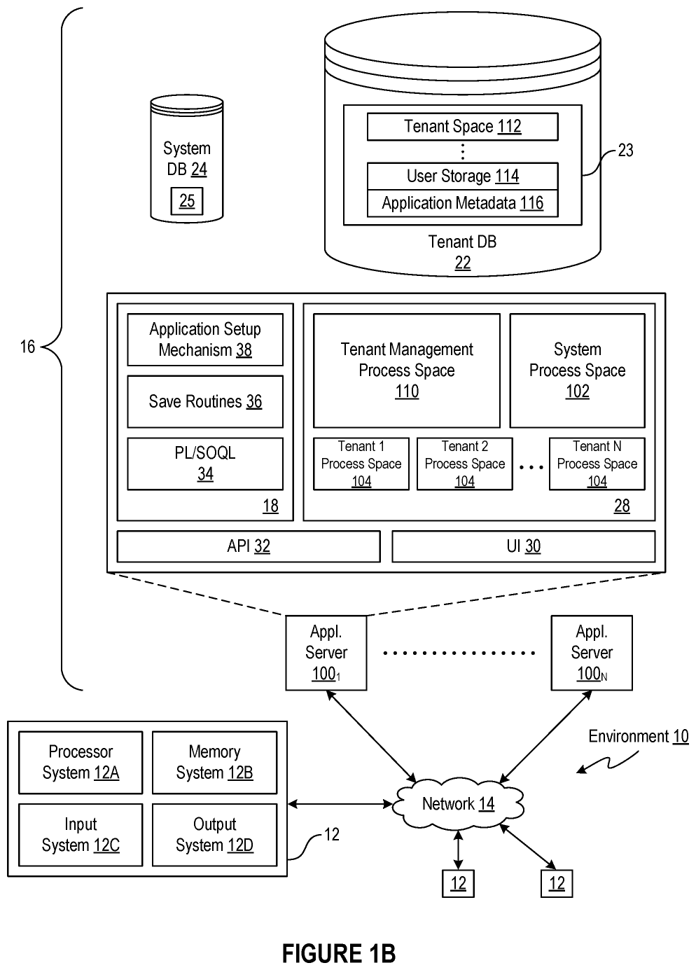

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the database system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the database system 16, is a service that is made available to users outside an enterprise (or enterprises) that owns, maintains, or provides access to the database system 16. An “enterprise” refers generally to a company or organization that owns one or more data centers that host various services and data sources. A “data center” refers generally to a physical location of various servers, machines, and network components utilized by an enterprise.

As described above, such users generally do not need to be concerned with building or maintaining the database system 16. Instead, resources provided by the database system 16 may be available for such users' use when the users need services provided by the database system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of the database system 16 to execute, such as the hardware or software infrastructure of the database system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the database system 16 implements a web-based customer relationship management (CRM) system. For example, in some such implementations, the database system 16 includes application servers configured to implement and execute CRM software applications as well as provide related data, code, forms, renderable web pages, and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The database system 16 also implements applications other than, or in addition to, a CRM application. For example, the database system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the database system 16.

According to some implementations, each database system 16 is configured to provide web pages, forms, applications, data, and media content to user (client) systems 12 to support the access by user systems 12 as tenants of the database system 16. As such, the database system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application, such as an object-oriented database management system (OODBMS) or a relational database management system (RDBMS), as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a local area network (LAN), wide area network (WAN), telephone network, wireless network, cellular network, point-to-point network, star network, token ring network, hub network, or other appropriate configuration. The network 14 can include a Transfer Control Protocol and Internet Protocol (TCP/IP) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with the database system 16 using TCP/IP and, at a higher network level, other common Internet protocols to communicate, such as the Hyper Text Transfer Protocol (HTTP), Hyper Text Transfer Protocol Secure (HTTPS), File Transfer Protocol (FTP), Apple File Service (AFS), Wireless Application Protocol (WAP), etc. In an example where HTTP is used, each user system 12 can include an HTTP client commonly referred to as a “web browser” or simply a “browser” for sending and receiving HTTP signals to and from an HTTP server of the database system 16. Such an HTTP server can be implemented as the sole network interface 20 between the database system 16 and the network 14, but other techniques can be used in addition to or instead of these techniques. In some implementations, the network interface 20 between the database system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, WAP-enabled device, or other computing device capable of interfacing directly or indirectly to the Internet or other network. When discussed in the context of a user, the terms “user system,” “user device,” and “user computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, personal digital assistant (PDA), or other wireless device, allowing a user (for example, a subscriber of on-demand services provided by the database system 16) of the user system 12 to access, process, and view information, pages, and applications available to it from the database system 16 over the network 14.

Each user system 12 also typically includes one or more user input devices, such as a keyboard, a mouse, a trackball, a touch pad, a touch screen, a pen or stylus, or the like, for interacting with a GUI provided by the browser on a display (for example, a monitor screen, liquid crystal display (LCD), light-emitting diode (LED) display, etc.) of the user system 12 in conjunction with pages, forms, applications, and other information provided by the database system 16 or other systems or servers. For example, the user interface device can be used to access data and applications hosted by database system 16, and to perform searches on stored data, or otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the database system 16, that user system can have the capacities allotted to the salesperson. However, while an administrator is using that user system 12 to interact with the database system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU), such as an Intel Pentium® processor or the like. Similarly, the database system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The database system 16 includes non-transitory computer-readable storage media having instructions stored thereon that are executable by or used to program a server or other computing system (or collection of such servers or computing systems) to perform some of the implementation of processes described herein. For example, the program code 26 can include instructions for operating and configuring the database system 16 to intercommunicate and to process web pages, applications, and other data and media content as described herein. In some implementations, the program code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, DVDs, CDs, microdrives, magneto-optical discs, magnetic or optical cards, nanosystems (including molecular memory integrated circuits), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™ JavaScript, ActiveX, any other scripting language, such as VBScript, and many other programming languages as are well known.

FIG. 1B shows a block diagram of example implementations of elements of FIG. 1A and example interconnections between these elements according to some implementations. That is, FIG. 1B also illustrates environment 10, but FIG. 1B, various elements of the database system 16 and various interconnections between such elements are shown with more specificity according to some more specific implementations. In some implementations, the database system 16 may not have the same elements as those described herein or may have other elements instead of, or in addition to, those described herein.

In FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 1001-100N. Each application server 100, also referred to herein as an “app server,” is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114, and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The database system 16 also includes a user interface (UI) 30 and an application programming interface (API) 32. The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process space 110, for example. Invocations to such applications can be coded using PL/SOQL 34, which provides a programming language style interface extension to the API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, issued on Jun. 1, 2010, and hereby incorporated by reference herein in its entirety and for all purposes. Invocations to applications can be detected by one or more system processes, which manage retrieving application metadata 116 for the subscriber making the invocation and executing the metadata as an application in a virtual machine.

Each application server 100 can be communicably coupled with tenant database 22 and system database 24, for example, having access to tenant data 23 and system data 25, respectively, via a different network connection. For example, one application server 1001 can be coupled via the network 14 (for example, the Internet), another application server 1002 can be coupled via a direct network link, and another application server 100_{N} can be coupled by yet a different network connection. Transfer Control Protocol and Internet Protocol (TCP/IP) are examples of typical protocols that can be used for communicating between application servers 100 and the database system 16. However, it will be apparent to one skilled in the art that other transport protocols can be used to optimize the database system 16 depending on the network interconnections used.

In some implementations, each application server 100 is configured to handle requests for any user associated with any organization that is a tenant of the database system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, database system 16 can be a multi-tenant system in which database system 16 handles storage of, and access to, different objects, data, and applications across disparate users and organizations.

In one example storage use case, one tenant can be a company that employs a sales force where each salesperson uses database system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by database system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the database system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the database system 16. Such requests and updates can involve sending one or more queries to tenant database 22 or system database 24. The database system 16 (for example, an application server 100 in the database system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, issued on Aug. 17, 2010, and hereby incorporated by reference herein in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

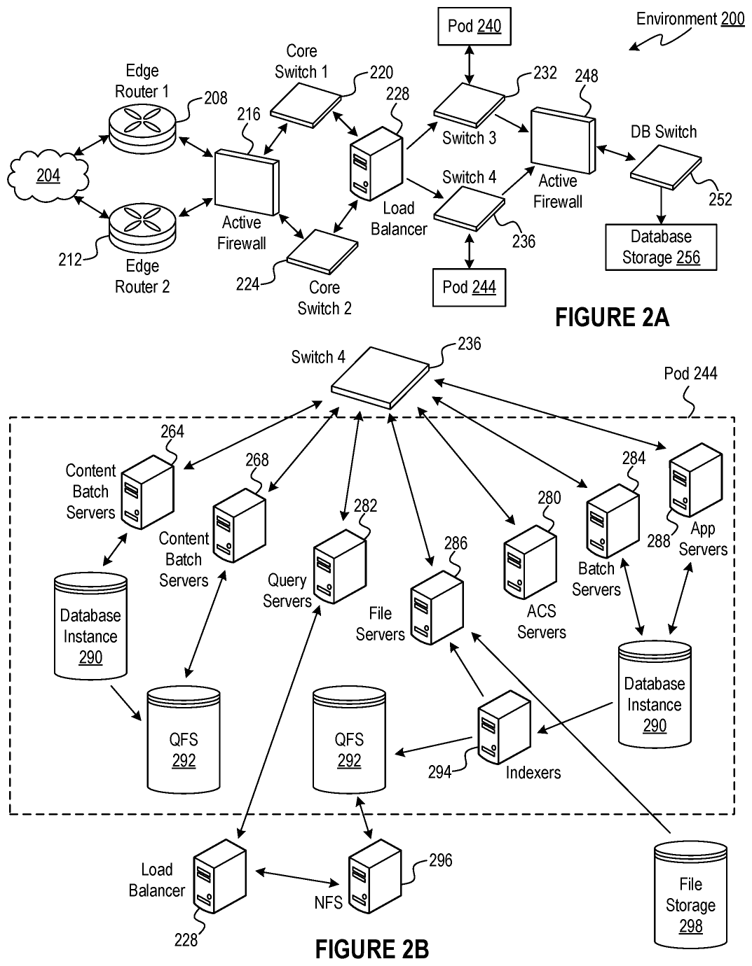

FIG. 2A shows a system diagram illustrating example architectural components of an on-demand database service environment 200 according to some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. The pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to several devices of each type. Also, the on-demand database service environment need not include each device shown in FIGS. 2A and 2B, or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server,” “device,” and “processing device” as used herein are not limited to a single hardware device; rather, references to these terms can include any suitable combination of hardware and software configured to provide the described functionality.

The cloud 204 is intended to refer to a data network or multiple data networks, often including the Internet. Client machines communicably connected with the cloud 204 can communicate with other components of the on-demand database service environment 200 to access services provided by the on-demand database service environment. For example, client machines can access the on-demand database service environment to retrieve, store, edit, or process information. In some implementations, the edge routers 208 and 212 route packets between the cloud 204 and other components of the on-demand database service environment 200. For example, the edge routers 208 and 212 can employ the Border Gateway Protocol (BGP). The BGP is the core routing protocol of the Internet. The edge routers 208 and 212 can maintain a table of Internet Protocol (IP) networks or ‘prefixes,’ which designate network reachability among autonomous systems on the Internet.

In some implementations, the firewall 216 can protect the inner components of the on-demand database service environment 200 from Internet traffic. The firewall 216 can block, permit, or deny access to the inner components of the on-demand database service environment 200 based upon a set of rules and other criteria. The firewall 216 can act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 can be configured as network bridges that quickly route data between different components within the on-demand database service environment. In some implementations, the use of two or more core switches 220 and 224 can provide redundancy or reduced latency.

In some implementations, the pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between the pods 240 and 244 is conducted via the pod switches 232 and 236. The pod switches 232 and 236 can facilitate communication between the pods 240 and 244 and client machines communicably connected with the cloud 204, for example, via core switches 220 and 224. Also, the pod switches 232 and 236 may facilitate communication between the pods 240 and 244 and the database storage 256. In some implementations, the load balancer 228 can distribute workload between the pods 240 and 244. Balancing the on-demand service requests between the pods can assist in improving the use of resources, increasing throughput, reducing response times, or reducing overhead. The load balancer 228 may include multilayer switches to analyze and forward traffic.

In some implementations, access to the database storage 256 is guarded by a database firewall 248. The database firewall 248 can act as a computer application firewall operating at the database application layer of a protocol stack. The database firewall 248 can protect the database storage 256 from application attacks such as SQL injection, database rootkits, and unauthorized information disclosure. In some implementations, the database firewall 248 includes a host using one or more forms of reverse proxy services to proxy traffic before passing it to a gateway router. The database firewall 248 can inspect the contents of database traffic and block certain content or database requests. The database firewall 248 can work on the SQL application level atop the TCP/IP stack, managing applications' connection to the database or SQL management interfaces as well as intercepting and enforcing packets traveling to or from a database network or application interface.

In some implementations, communication with the database storage 256 is conducted via the database switch 252. The multi-tenant database storage 256 can include more than one hardware or software components for handling database queries. Accordingly, the database switch 252 can direct database queries transmitted by other components of the on-demand database service environment (for example, the pods 240 and 244) to the correct components within the database storage 256. In some implementations, the database storage 256 is an on-demand database system shared by many different organizations as described above with reference to FIGS. 1A and 1B.

FIG. 2B shows a system diagram further illustrating example architectural components of an on-demand database service environment according to some implementations. The pod 244 can be used to render services to a user of the on-demand database service environment 200. In some implementations, each pod includes a variety of servers or other systems. The pod 244 includes one or more content batch servers 264, content search servers 268, query servers 282, file servers 286, access control system (ACS) servers 280, batch servers 284, and app servers 288. The pod 244 also can include database instances 290, quick file systems (QFS) 292, and indexers 294. In some implementations, some or all communication between the servers in the pod 244 can be transmitted via the pod switch 236.

In some implementations, the app servers 288 include a hardware or software framework dedicated to the execution of procedures (for example, programs, routines, scripts) for supporting the construction of applications provided by the on-demand database service environment 200 via the pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

The content batch servers 264 can handle requests internal to the pod. Some such requests can be long-running or not tied to a particular customer. For example, the content batch servers 264 can handle requests related to log mining, cleanup work, and maintenance tasks. The content search servers 268 can provide query and indexer functions. For example, the functions provided by the content search servers 268 can allow users to search through content stored in the on-demand database service environment. The file servers 286 can manage requests for information stored in the file storage 298. The file storage 298 can store information such as documents, images, and binary large objects (BLOBs). By managing requests for information using the file servers 286, the image footprint on the database can be reduced. The query servers 282 can be used to retrieve information from one or more file systems. For example, the query servers 282 can receive requests for information from the app servers 288 and transmit information queries to the network file systems (NFS) 296 located outside the pod.

The pod 244 can share a database instance 290 configured as a multi-tenant environment in which different organizations share access to the same database. Additionally, services rendered by the pod 244 may call upon various hardware or software resources. In some implementations, the ACS servers 280 control access to data, hardware resources, or software resources. In some implementations, the batch servers 284 process batch jobs, which are used to run tasks at specified times. For example, the batch servers 284 can transmit instructions to other servers, such as the app servers 288, to trigger the batch jobs.

In some implementations, the QFS 292 is an open source file system available from Sun Microsystems, Inc. The QFS can serve as a rapid-access file system for storing and accessing information available within the pod 244. The QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in the NFS 296 or other storage systems.

In some implementations, one or more query servers 282 communicate with the NFS 296 to retrieve or update information stored outside of the pod 244. The NFS 296 can allow servers located in the pod 244 to access information to access files over a network in a manner similar to how local storage is accessed. In some implementations, queries from the query servers 282 are transmitted to the NFS 296 via the load balancer 228, which can distribute resource requests over various resources available in the on-demand database service environment. The NFS 296 also can communicate with the QFS 292 to update the information stored on the NFS 296 or to provide information to the QFS 292 for use by servers located within the pod 244.

In some implementations, the pod includes one or more database instances 290. The database instance 290 can transmit information to the QFS 292. When information is transmitted to the QFS, it can be available for use by servers within the pod 244 without using an additional database call. In some implementations, database information is transmitted to the indexer 294. Indexer 294 can provide an index of information available in the database instance 290 or QFS 292. The index information can be provided to the file servers 286 or the QFS 292.

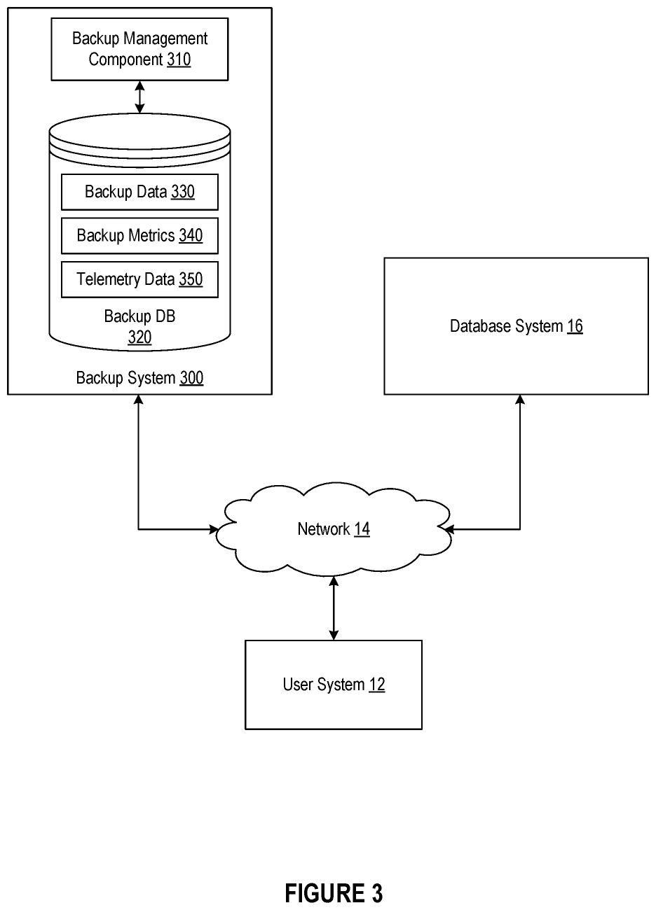

FIG. 3 shows a block diagram of example implementations of a backup system 300 according to some implementations. In some implementations, the backup system 300 is configured to receive and maintain data (e.g., file system data) from one or more devices accessible via the network 14. The backup system 300 may protect a large volume of data while supporting stringent requirements specified by a service-level agreement, including RTO requirements and RPO requirements. The backup system 300 may simplify and consolidate all backup process infrastructure for each system that it services to eliminate the need for such systems to utilize separate backup processes.

The backup system 300 includes a backup management component 310 for managing data stored in a backup database 320. In some implementations, the backup management component 310 may be implemented as software run by the backup system 300, as firmware, or as hardware. In some implementations, the backup management component 310 is responsible for the generation of backups, the movement of backup data to onsite and offsite archives, and the aging off of the archive backups. The backup management component 310 may further implement recovery operations based on stored backup data, for example, in response to a recovery request or automatically in response to a detected database failure in the database system 16.

The backup database 320 includes backup data 330, which maintains backups generated by the backup management component 310 for various databases or subsets thereof accessible through the network 14. The backup data 330 can include point-in-time data, and may be indexed to enable a user to identify a point in time to use as a restore point. The backup database 320 may maintain backups of data from the user system 12 or any databases managed by the database system 16 (e.g., the tenant database 22). The backup management component 310 maintains record of each backup and its log sequence number (LSN) in backup metrics 340 of the backup database 320, and uses this data to validate the presence of each of files across storage locations. Metadata pertaining to backup generation and recover may also be stored in the backup metrics 340. Such metadata may include, but is not limited to: a time of the most recent modification of a data file; a date file name; a data file size; information about content of the data file; a data file creation date; a data file type; last accessed time of the data file; a type of application that generated the data file; and a location of the data file and a network pathway to/from the data file. In some implementations, the backup metrics 340 further include historical performance information for prior restore operations including but not limited to average time to restore per GB of FILE, TLOG, and PDIFF backups, and most recent recovery times for FILE, PDIFF, and TLOG backups.

The backup database 320 further includes telemetry data 350, which stores environmental signals that may correspond to or be derived from telemetry data associated with the database system 16 and the backup system 300. In some implementations, environmental signals include, but are not limited to: maximum data streams per storage device without significant impact to system performance; maximum streams per operating system node without significant impact to system performance; current production 10 workload, including both disk and network; bandwidth availability for cloud uploads; GB changed since last FILE backup generated; active transaction log size; and oldest active transaction in the transaction log.

In some implementations, the backup management component 310 is implemented as a recovery solution for SQL Server that does not rely on predefined backup schedules, but instead consumes signals from the computing environment which are used in connection with historical performance to comply with recovery RPO and RTO requirements. The backup management component 310 may compute an RPO for a particular database based on an LSN associated with the database and the time a backup was generated to extrapolate to what point it time can be recovered with what files are validated to be present. Using the LSN of each FILE backup, the PDIFF backup, and each TLOG backup, islands of recoverability can be computed that indicate all points in time to which recovery can be made, including the most recent point in the past (which corresponds to the RPO).

The backup management component 310 may compute an RTO based upon an average time required to restore a GB of data for each of the backup types (e.g., FILE, PDIFF, and TLOG backups) and based on the availability of each of the backup files. The backup management component 310 maintains information about which backups are available (FILE, PDIFF, and TLOG) and the LSN intervals that are covered by these backups. As an example, it make require 20 seconds for each GB of FILE and PDIFF backups, and 10 seconds for each GB of TLOG backup that must be applied in a recovery operation. For a database with 10 files of 100 GB each, it would require a minimum of 2000 seconds (33 minutes) to restore each FILE backup. The backup management component 310 can calculate whether it is more efficient to restore 20 GB of PDIFF backup plus 20 GB of TLOG backup (10 minutes) or 100 GB of TLOG (17 minutes) to restore the database up to the most recent point in time. In this case, the RTO would be either 43 or 50 minutes depending on the method chosen to restore.

In addition to RPO and RTO requirements, the backup management component 310 may also account for other requirements. Certification and legal obligations (e.g., HITRUST compliance, GDPR compliance, etc.) may also drive the backup process to ensure that backups cover specific lengths of time. As an example, HITRUST compliance requires that at least one full backup be copied offsite weekly in addition to every differential or incremental backup.

In some implementations, the backup management component 310 keeps track of current performance characteristics of each tier in the environment 10 by tracking and consuming environmental signals. The backup management component 310 is capable of spinning up parallel backup threads until the performance of each of these tiers nears an unsafe level with respect to compliance requirements. At that point, existing backups are allowed to finish, but no new backups are permitted at that particular tier unless SLA requirements are breached at that time. In some implementations, if a backup is anticipated to cause the application to become unresponsive, this backup is not generated. If SLA requirements are breached, an alert is generated to notify a supporting team of users to understand what caused the breach exists and to identify any remedial mechanisms to return to below a below-critical level to allow backup generation to proceed.

Although the backup system 300 is illustrated as being separate from the database system 16, it is to be understood that this implementation is exemplary. In other implementations, the backup system 300, or a portion thereof, may be incorporated into the database system 16. In some implementations, for example, the database system 16 may implement the backup management component 310, and the backup database 320 may be maintained by a separate system. As another example, backup data 330 may be stored in a separate system while backup metrics 340 and telemetry data 350 may be stored in and maintained by the database system 16.

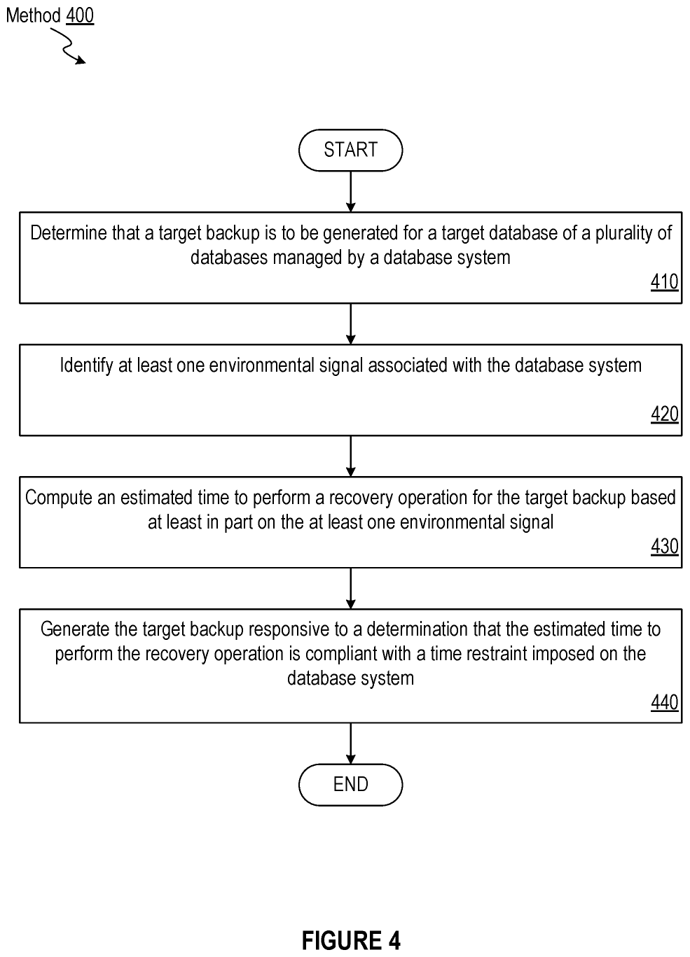

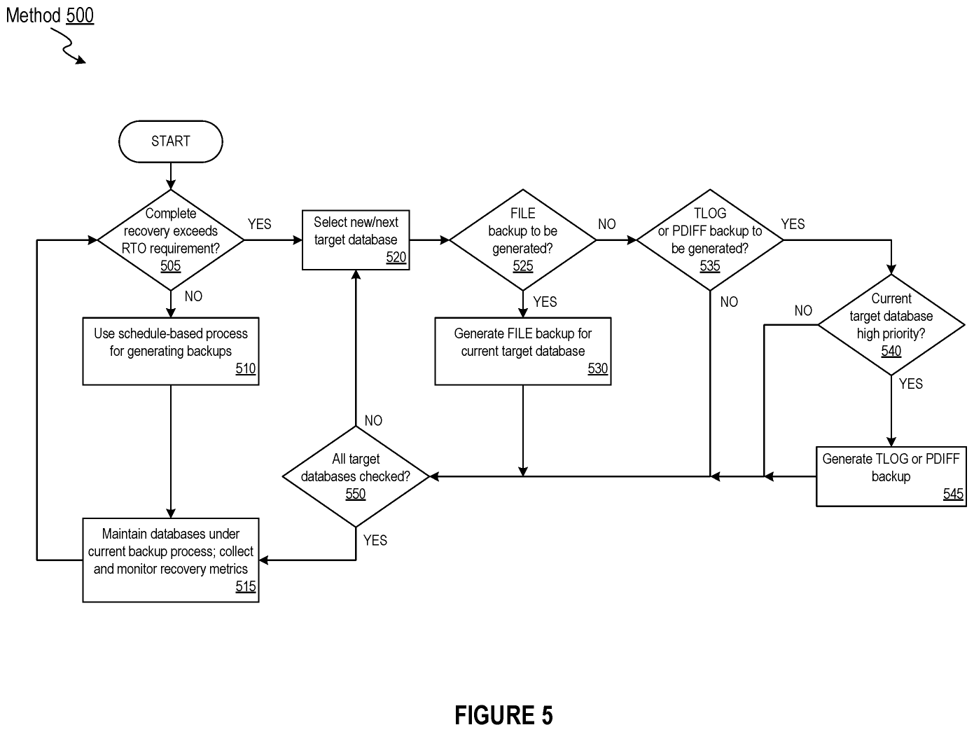

FIGS. 4 and 5 are flow diagrams illustrating exemplary methods 400 and 500, respectively for generating database backups in response to environmental signals according to some implementations. The methods 400 and 500 may be performed by processing logic comprising hardware (e.g., circuitry, dedicated logic, programmable logic, microcode, etc.), software (such as instructions run on a processing device), or a combination thereof. In some implementations, the methods 400 and 500 may be performed by a backup system 300 (e.g., utilizing the functionality of the backup management component 310), by one or more processing devices associated with a host database system (e.g., the application server 100 utilizing the functionality of the backup management component 310), another device, or a combination thereof. Although the implementations of the methods 400 and 500 are discussed with respect to the backup system 300, it is to be understood that these implementations are merely exemplary, and that other devices may perform some or all of the functionality described.

Referring to FIG. 4, at block 410, a processing device (e.g., a processing device of the backup system 300) determines that a target backup is to be generated for a target database of a plurality of databases managed by a database system (e.g., the database system 16). The database system may manage the plurality of databases for which backups are managed by a backup system (e.g., the backup system 300). Each backup generated for the databases may be stored in one or more backup databases (e.g., backup data 330 of the backup database 320), which may be stored as part of the database system or stored separately (e.g., onsite or offsite). In some implementations, the order in which backups are to be generated for the plurality of databases may be based on a prioritization of backup generation, with each database having an associated priority level. For example, in some implementations, the processing device selects the target database for generating the target backup thereof responsive to determining that the target database has a high or highest priority level. The priority level may be assigned, for example, based on compliance with one or more SLA requirements imposed on the database system. For example, an SLA requirement may be that a backup for each database or a subset of databases is generated in accordance with a particular time restraint (e.g., a backup for a given database must be generated every Sunday). In some implementations, databases that have breached or are closer to breaching an SLA requirement than other databases may be assigned a greater priority over other databases.

While time restraints may, in some implementations, dictate when backups must be generated, this is different from predefined scheduling of backup generation. In such implementations, the prioritization may govern when a backup is generated rather than predetermined scheduling (e.g., the backup must be generated for a given database before the end of a one-week period but not at any particular time; by contrast, a predetermined scheduling requirement may require that backup generation for the given database is initiated every Sunday at 11:59 pm).

At block 420, the processing device identifies at least one environmental signal associated with the database system. The at least one environmental signal may be derived, for example, from telemetry data (e.g., telemetry data 350) or other data (e.g., backup metrics 340). Telemetry data may include, for example, a maximum number of streams per storage device, a maximum number of streams per operating system node, current production input/output workload, a bandwidth availability, a memory size change since a previous FILE backup, an active transaction log size, an oldest active transaction in a transaction log, or a combination thereof.

At block 430, the processing device computes an estimated time to perform a recovery operation for the target backup based at least in part on the at least one environmental signal. In some implementations, the processing device computes the estimated time based on the at least one environmental signal, historical data, or a combination thereof. The historical data may include, for example, data descriptive of time required to perform previous recovery operations. For example, the processing device may identify in the historical data a recovery operation corresponding to a backup size similar to the size of the target backup to estimate an amount of recovery time needed for the target backup. In another example, the processing device may consider the size of a prior backup and also account for telemetric data, such as data transport capacity, to estimate the recovery time.

At block 440, the processing device generates the target backup responsive to a determination that the estimated time to perform the recovery operation is compliant with a time restraint imposed on the database system. In some implementations, the time restraint imposed on the database system is a recovery time objective requirement, which may be specified as part of a service-level agreement.

In some implementations, the processing device determines a backup type of the target backup. The backup type may be determined based at least in part on the at least one environmental signal, historical data, and other factors (such as SLA requirements), and may be, for example, a FILE backup, a FULL backup, a DIFF backup, a PDIFF backup, a TLOG backup, or a combination thereof.

In some implementations, the processing device performs the recovery operation for the target backup (e.g., in response to a failure event). Data generated by the recovery operation may be stored, for example, with historical data descriptive of other previously performed recovery operations. For example, the stored data may include an amount of time required to perform the recovery operation for the target backup.

Reference is now made to FIG. 5, which is a flow diagram illustrating an exemplary method 500 for determining a type of backup to generate according to some implementations. At block 505, a processing device determines whether a complete recovery of all databases managed by a database system (e.g., the database system 16) exceeds an RTO requirement. For example, this may be true if an estimated total amount of time to recover all of the databases is greater than the maximum downtime of the database system as stipulated by the RTO requirement. The processing device may make this determination by estimating a total amount of time to recover all of the databases, for example, based on historical recovery data and telemetry data. If the processing device determines that complete recovery would exceed the RTO requirement, then the method 500 proceeds to block 510. At block 510, the database system begins to utilize a schedule-based process for generating backups such that each required backup is scheduled to occur at a specific time.

If the processing device determines that complete recovery would exceed the RTO requirement, then the method 500 proceeds to block 520 where a target database is selected from a plurality of databases managed by the database system. Block 520, its downstream blocks, and the block 550 form a closed loop such that the processing device can iterate through all databases to determine whether a backup should be generated for each.

At block 525, the processing device determines whether a FILE backup is to be generated for the current target database. In some implementations, a new FILE backup will be generated if one of the following conditions is true: (1) there is no prior FILE backup present for the current target database (e.g., the current target database was recently created or included among the plurality of databases for which a backup solution is desired); (2) the sum total of recovery time required to apply the prior FILE backup and a PDIFF backup generated with respect to the prior FILE backup exceeds the time required to apply the new FILE backup; and (3) a certification or legal requirement necessitates the generation of the new FILE backup. If the processing device determines that a FILE backup is to be generated for the current target database, then the method 500 proceeds to block 530 where a FILE backup is generated for the current target database. In some implementations, multiple FILE backups are generated for the current target database for each file contained therein for which no previous FILE backup has been generated. The method 500 then proceeds to block 550.

If the processing device determines that a FILE backup is not to be generated for the current target database, then the method 500 proceeds to block 535, where the processing device determines whether a TLOG backup or a PDIFF backup is to be generated for the current target database. In some implementations, a TLOG backup may be generated based on an analysis of some or all of the databases to determine the oldest active transaction and a size of the active transaction log. A TLOG backup may be generated, for example, if the processing device determines that the current target database corresponds to the oldest active transaction in the transaction log, or if the size of the active transaction log exceeds a threshold and generating a TLOG for the current target database reduces the size of the active transaction log to below the threshold. In some implementations, a PDIFF backup will be generated when a duration required for a TLOG backup restore would be estimated to exceed an RTO requirement. In some implementations, the processing device may determine that no backup is to be generated, for example, when generation of a backup for the current target database is already in progress.

If the processing determines that a TLOG backup or a PDIFF backup is not to be generated for the current target database, then the method 500 proceeds to block 550. Otherwise, if the processing device determines that a TLOG backup or a PDIFF backup is to be generated for the current target database, then the method 500 proceeds to block 540, where the processing device determines whether the current target database meets a priority threshold. In some implementations, the processing device may assign to each database a priority level. If the processing device determines that the priority level exceeds a priority threshold, the method 500 proceeds to block 545 where a TLOG backup or PDIFF backup is generated for the current target database and is stored in a backup database (e.g., the backup database 320). The priority threshold may be computed based on various environmental signals, SLA requirements, and other factors. A low priority threshold or zero priority threshold may be indicative of a low risk of breaching an RTO requirement. In this situation, TLOG and PDIFF backups may be generated regularly for each database as the processing device iterates through the database. A high priority threshold may be indicative of a high risk of breaching an RTO requirement, or indicative that the RTO requirement has been breached. In this situation, only high priority level databases will have backups generated. In some implementations, this delays backups from being generated for compliant databases until backups are generated for databases that are in breach of or are likely to be in breach of SLA requirements.

At block 550, the processing device determines whether all databases have been iterated through. If not, then the method 500 proceeds to block 520 where the next target database is selected. Otherwise, the method 500 proceeds to block 515 where the processing device continues to maintain the databases under the current backup process, and continues to collect and monitor recovery metrics and telemetry data. At block 515, priority levels for each database may be updated as well as the priority threshold. In some implementations, the method 500 proceeds to block 505 and repeats continuously. In some implementations, the method 500 may bypass block 505 and proceeds to block 520 unless a predetermined time has elapsed (e.g., the processing device may check weekly the status of the database system to determine whether which backup process should be used).

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring instructions for performing such methods to computing devices. The term “article of manufacture,” as used herein, is intended to encompass a computer program accessible from any computer-readable device or storage media.

The following illustrative example is set forth to assist in understanding the embodiments described herein and should not be construed as specifically limiting the embodiments described and claimed herein. Such variations, including the substitution of all equivalents now known or later developed, which would be within the purview of those skilled in the art, and changes thereto are to be considered to fall within the scope of the embodiments incorporated herein.

This example tracks the lifecycle of a database referred to as “DB1” from inception to recovery. DB1 is a new database managed by a database system, and has 100 files that are 500 GB each, totaling 50 terabytes (TB). DB1 maintains a consistent 1 GB of transaction log activity every minute. A backup system (e.g., the backup system 300) determines that this database is in production, and the initial RPO and RTO requirements are calculated at zero. This results in DB1 being assigned the highest priority level in the database system.

At the inception of DB1, there are no FILE backups for DB1 in the backup system, and the database, node, and storage array are currently below the threshold for application performance. Accordingly, the backup system immediately initiates the generation of a FILE backup for the files of DB1. As many backups as can be sustained without exceeding a performance threshold are executed in parallel to advance DB1 to a non-zero RPO as quickly as possible. During this initial process, other databases managed by the database system may be allowed to move closer to breaching SLA requirements than they normally would because DB1 is currently prioritized above all others given its zero RPO (which the backup system treats as a breach). Transaction log thresholds (oldest active and active size) may still be used to generate regular TLOG backups while the FILE backups are being generated.

Once FILE backups complete for all 100 files of DB1, RPO for DB1 is now non-zero. Backups for this new database are now prioritized accordingly, allowing the other databases to catch up and the system to stabilize.

As the RTO starts to move toward the 1 hour threshold due to the number of TLOG backups required to make DB1 current, a PDIFF backup of the files that would cause the RTO to exceed SLA requirements is taken. This process of generating a PDIFF for files occurs regularly as the amount of time to restore the chain of TLOG backups increases as the total size to apply the backups grows.

As the one-week mark since inception is approached, HITRUST compliance dictates a FULL backup every week. The backup system will detect this approaching SLA requirement and begin archiving FILE backups, resetting the PDIFF base and setting the cycle back.

During the following week, a significant amount of change occurs in DB1. The backup system determines that the RTO to apply the current FILE and PDIFF for files 10-18 could exceed an SLA threshold. A new FILE backup is then executed for these files, eliminating the need to apply the PDIFF and setting the RTO back to well within threshold.

A restore is requested by the product team to recover the database to a specific point in time as of this week. The backup system is able to use a point in time as a parameter, and builds out the recovery solution as follows: (1) FILE backups generated the prior week are restored for all files except 10-18; (2) FILE backups generated this week are restored for files 10-18; (3) a PDIFF backup is used for each of the files except for 10-18; and (4) TLOG backups are applied from the LSN of the oldest PDIFF backup up to the point in time requested by the product team.

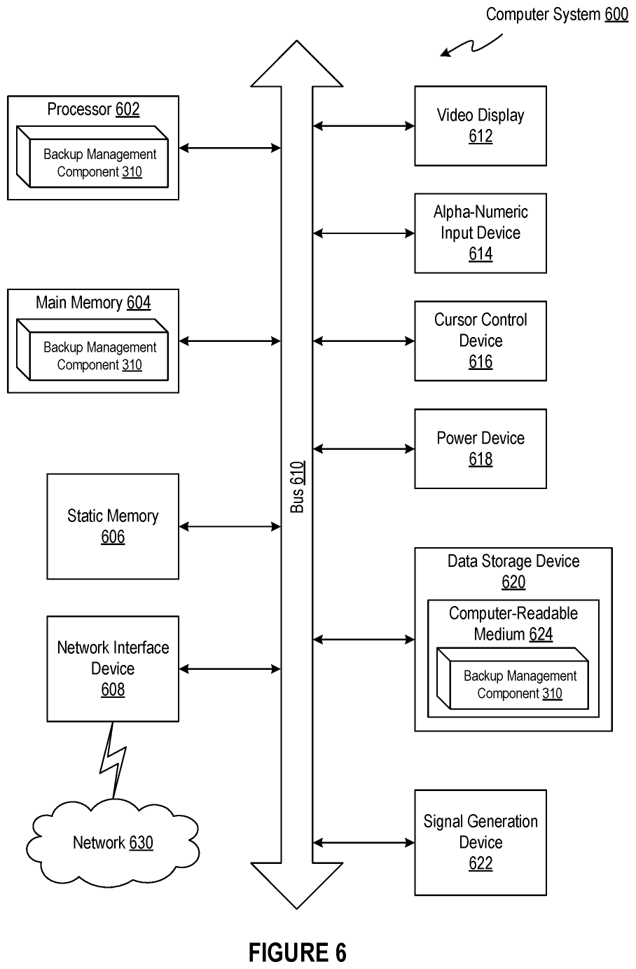

FIG. 6 illustrates a diagrammatic representation of a machine in the exemplary form of a computer system 600 within which a set of instructions (e.g., for causing the machine to perform any one or more of the methodologies discussed herein) may be executed. In alternative implementations, the machine may be connected (e.g., networked) to other machines in a LAN, a WAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a PDA, a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 600 may be utilized by or illustrative of any of the electronic components described herein (e.g., any of the components illustrated in or described with respect to FIGS. 1A, 1B, 2A, 2B, and 3).

The exemplary computer system 600 includes a processing device (processor) 602, a main memory 604 (e.g., ROM, flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 620, which communicate with each other via a bus 610.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions for performing the operations and steps discussed herein, such as some or all of the functionality described with respect to the backup management component 310.

The computer system 600 may further include a network interface device 608. The computer system 600 also may include a video display unit 612 (e.g., a liquid crystal display (LCD), a cathode ray tube (CRT), or a touch screen), an alphanumeric input device 614 (e.g., a keyboard), a cursor control device 616 (e.g., a mouse), and a signal generation device 622 (e.g., a speaker).

Power device 618 may monitor a power level of a battery used to power the computer system 600 or one or more of its components. The power device 618 may provide one or more interfaces to provide an indication of a power level, a time window remaining prior to shutdown of computer system 600 or one or more of its components, a power consumption rate, an indicator of whether computer system is utilizing an external power source or battery power, and other power related information. In some implementations, indications related to the power device 618 may be accessible remotely (e.g., accessible to a remote backup management module via a network connection). In some implementations, a battery utilized by the power device 618 may be an uninterruptable power supply (UPS) local to or remote from computer system 600. In such implementations, the power device 618 may provide information about a power level of the UPS.

The data storage device 620 may include a computer-readable storage medium 624 (e.g., a non-transitory computer-readable storage medium) on which is stored one or more sets of instructions (e.g., software) embodying any one or more of the methodologies or functions described herein, such as some or all of the functionality described with respect to the backup management component 310. These instructions may also reside, completely or at least partially, within the main memory 604 and/or within the processor 602 during execution thereof by the computer system 600, the main memory 604, and the processor 602 also constituting computer-readable storage media. These instructions may further be transmitted or received over a network 630 (e.g., the network 14) via the network interface device 608. While the computer-readable storage medium 624 is shown in an exemplary implementation to be a single medium, it is to be understood that the computer-readable storage medium 624 may include a single medium or multiple media (e.g., a centralized or distributed database, and/or associated caches and servers) that store the one or more sets of instructions.

In the foregoing description, numerous details are set forth. It will be apparent, however, to one of ordinary skill in the art having the benefit of this disclosure, that the present disclosure may be practiced without these specific details. While specific implementations have been described herein, it should be understood that they have been presented by way of example only, and not limitation. The breadth and scope of the present application should not be limited by any of the implementations described herein, but should be defined only in accordance with the following and later-submitted claims and their equivalents. Indeed, other various implementations of and modifications to the present disclosure, in addition to those described herein, will be apparent to those of ordinary skill in the art from the foregoing description and accompanying drawings. Thus, such other implementations and modifications are intended to fall within the scope of the present disclosure.

Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

What is claimed is:

1. A computer-implemented method comprising:
determining, by a processing device, that a target backup is to be generated for a target database of a plurality of databases managed by a database system;
identifying, by the processing device, at least one environmental signal associated with the database system;
computing, by the processing device, an estimated time to perform a recovery operation for the target backup based at least in part on the at least one environmental signal; and
generating, by the processing device, the target backup responsive to a determination that the estimated time to perform the recovery operation is compliant with a time restraint imposed on the database system.

2. The method of claim 1, wherein determining that the target backup is to be generated for the target database comprises generating, by the processing device, the target backup based on a priority level associated with the target database, the priority level being representative of a prioritization of when backups are to be generated for each of the plurality of databases.

3. The method of claim 2, wherein the prioritization is based on compliance with a service-level agreement requirement imposed on the database system, and wherein the prioritization is not based on a predefined schedule of backup generation.

4. The computer-implemented method of claim 1, wherein the at least one environmental signal comprises telemetry data selected from one or more of a maximum number of streams per storage device, a maximum number of streams per operating system node, current production input/output workload, a bandwidth availability, a memory size change since a previous database file backup, an active transaction log size, and an oldest active transaction in a transaction log.

5. The method of claim 1, wherein computing the estimated time to perform a recovery operation comprises computing the estimated time based on the at least one environmental signal and historical data descriptive of time required to perform previous recovery operations.

6. The method of claim 1, wherein the time restraint imposed on the database system is a recovery time objective requirement.

7. The computer-implemented method of claim 1, further comprising:
determining, by the processing device, a backup type of the target backup to be generated for the target database based at least in part on the at least one environmental signal, wherein the backup type is selected from a group consisting of a database file (FILE) backup, a full (FULL) backup, a differential (DIFF) backup, a partial differential (PDIFF) backup, and an incremental log (TLOG) backup.

8. The computer-implemented method of claim 1, further comprising:
performing, by the processing device, the recovery operation for the target backup; and
causing, by the processing device, data descriptive of an amount of time to perform the recovery operation to be stored in a backup database, the backup database comprising historical data descriptive of time required to perform previous recovery operations.

9. A database system comprising:
a processing device; and
a memory device coupled to the processing device, the memory device having instructions stored thereon that, in response to execution by the processing device, cause the processing device to:
determine that a target backup is to be generated for a target database of a plurality of databases managed by the database system;
identify at least one environmental signal associated with the database system;
compute an estimated time to perform a recovery operation for the target backup based at least in part on the at least one environmental signal; and
generate the target backup responsive to a determination that the estimated time to perform the recovery operation is compliant with a time restraint imposed on the database system.

10. The database system of claim 9, wherein to determine that the target backup is to be generated for the target database, the processing device is to further generate the target backup based on a priority level associated with the target database, the priority level being representative of a prioritization of when backups are to be generated for each of the plurality of databases.

11. The database system of claim 10, wherein the prioritization is based on compliance with a service-level agreement requirement imposed on the database system, and wherein the prioritization is not based on a predefined schedule of backup generation.

12. The database system of claim 9, wherein the at least one environmental signal comprises telemetry data selected from one or more of a maximum number of streams per storage device, a maximum number of streams per operating system node, current production input/output workload, a bandwidth availability, a memory size change since a previous database file backup, an active transaction log size, and an oldest active transaction in a transaction log.

13. The database system of claim 9, wherein to compute the estimated time to perform a recovery operation, the processing device is to further compute the estimated time based on the at least one environmental signal and historical data descriptive of time required to perform previous recovery operations.

14. The database system of claim 9, wherein the time restraint imposed on the database system is a recovery time objective requirement.

15. The database system of claim 9, wherein the processing device is to further:
determine a backup type of the target backup to be generated for the target database based at least in part on the at least one environmental signal, wherein the backup type is selected from a group consisting of a database file (FILE) backup, a full (FULL) backup, a differential (DIFF) backup, a partial differential (PDIFF) backup, and an incremental log (TLOG) backup.

16. A non-transitory computer-readable storage medium having instructions encoded thereon which, when executed by a processing device, cause the processing device to:
determine that a target backup is to be generated for a target database of a plurality of databases managed by the database system;
identify at least one environmental signal associated with the database system;
compute an estimated time to perform a recovery operation for the target backup based at least in part on the at least one environmental signal; and
generate the target backup responsive to a determination that the estimated time to perform the recovery operation is compliant with a time restraint imposed on the database system.

17. The non-transitory computer-readable storage medium of claim 16, wherein to determine that the target backup is to be generated for the target database, the processing device is to further generate the target backup based on a priority level associated with the target database, the priority level being representative of a prioritization of when backups are to be generated for each of the plurality of databases.

18. The non-transitory computer-readable storage medium of claim 17, wherein the prioritization is based on compliance with a service-level agreement requirement imposed on the database system, and wherein the prioritization is not based on a predefined schedule of backup generation.

19. The non-transitory computer-readable storage medium of claim 16, wherein the at least one environmental signal comprises telemetry data selected from one or more of a maximum number of streams per storage device, a maximum number of streams per operating system node, current production input/output workload, a bandwidth availability, a memory size change since a previous database file backup, an active transaction log size, and an oldest active transaction in a transaction log.

20. The non-transitory computer-readable storage medium of claim 16, wherein to compute the estimated time to perform a recovery operation, the processing device is to further compute the estimated time based on the at least one environmental signal and historical data descriptive of time required to perform previous recovery operations, and wherein the processing device is to further:
determine a backup type of the target backup to be generated for the target database based at least in part on the at least one environmental signal, wherein the backup type is selected from a group consisting of a database file (FILE) backup, a full (FULL) backup, a differential (DIFF) backup, a partial differential (PDIFF) backup, and an incremental log (TLOG) backup.
